(19) United States
(12) Patent Application Publication
(10) Pub. No.: US 2005/0136988 A1
(43) Pub. Date: Jun. 23, 2005

(54) Method for reporting personal status of a mobile communication device user and method therefor

(76) Inventors: Camilo E. Villamil, Pembroke Pines, FL (US); Eric T. Eaton, Lake Worth, FL (US); Scott M. Garrett, Weston, FL (US)

Correspondence Address: Scott M. Garrett;Motorola, Inc., 8000 West Sunrise Boulevard, Fort Lauderdale, FL, 33322, US

(21) Appl. No.: 10/743,514

(22) Filed: Dec. 19, 2003

(51) Int. Cl. H04Q 7/32

(52) U.S. Cl. 455/567; 455/550.1

(57) ABSTRACT

A mobile communication device contains event descriptor files that define certain detectable parameters indicative of the occurrence of an event. When the mobile communication device has determined that an event has occurred, the mobile communication device proceeds to send a status message to a preselected party, indicating to the preselected party that the user of the mobile communication device has experienced the event. A wide variety of events may be described and detected, such as arrival at a particular geographic location. The mobile communication device may prompt the user before sending the status message, and may further require the user to verify the user's identity by an authentication procedure.

### TECHNICAL FIELD

This invention relates in general to mobile communication devices, and more particularly to status reporting in response to events experienced by the mobile communication device.

BACKGROUND OF THE INVENTION Mobile communication devices are in widespread use and have become especially common in metropolitan areas. Originally these devices supported mobile radio telephony service, allowing users to both communicate without a land line telephone, and to move while engaged in a telephone call. More recently, however, these device have been developed to support a wide variety of communication and personal services. Most mobile communication devices presently sold include a network interface for sending and receiving data and data messages. The ability to engage in data communications has transformed mobile communication devices into personal communication assistants, allowing for a wide variety of applications to be used on the mobile communication device, including application for portable application environments, such as Java.

The advancement of mobile communications has enabled society to be more mobile, and many people depend on their mobile communication device to keep in touch, not just with business associates, but with friends and family as well. Many occupations require frequent travel, and thus concerns about the traveler's safety. Of course, a person could simply use the mobile communication device to call home. However, such calls may be charged against the person's account and may

Once the mobile communication device has determined an event has occurred corresponding to an event defined by one or more event descriptors, the mobile communication device may automatically transmit a status response message, or it may prompt the user of the mobile communication device before transmitting the status response message. The status response message may be sent directly from the mobile communication device to the preselected party, or alternatively the mobile communication device may request the communication system send a message according to a predefined event response profile stored on a database 124 of the communication system. In the latter case the user of the mobile communication device has access to the database under an agreement with the communication system operator soothe user can configure the event response profile. The status response message can take a variety of forms, such as, for example, a phone call for transmitting a brief announcement, a text message sent via a short message service (SMS) transmission, an email message, and so on. Therefore, once the mobile communication device has determined an event has occurred, and it commences responding, the response may be delivered by a mobile telephony or mobile data channel 124, a standard landline telephony line 126, or a data network 128.

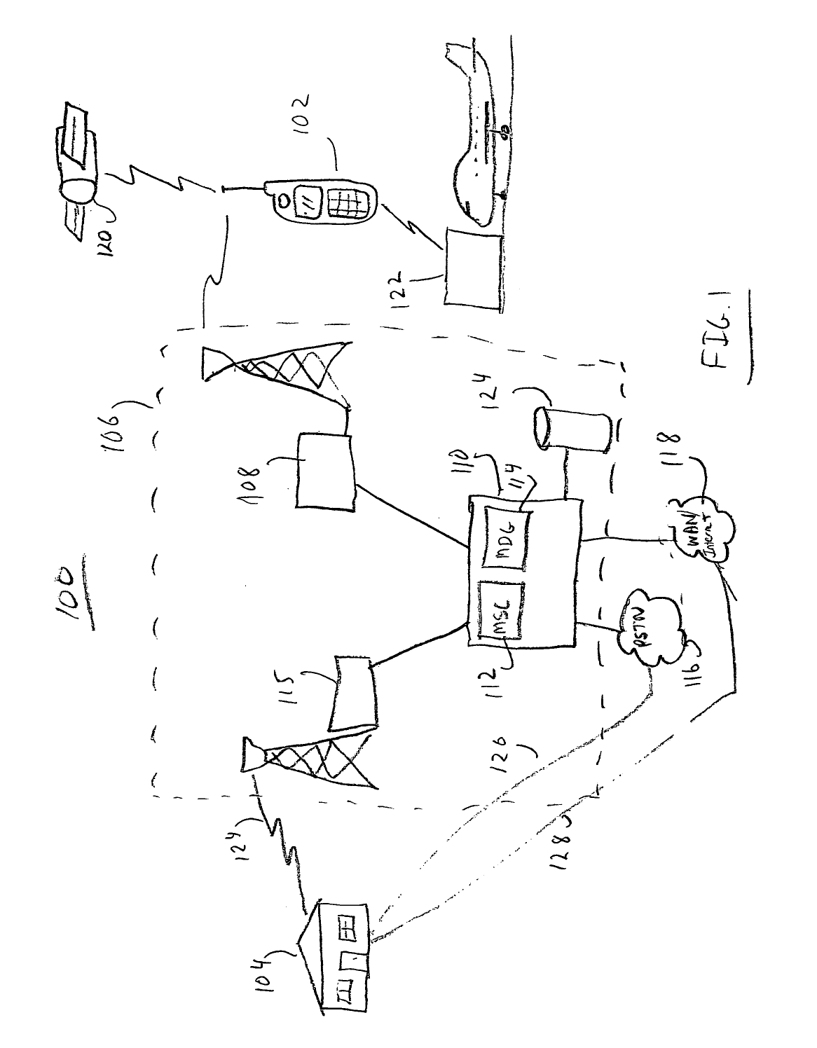

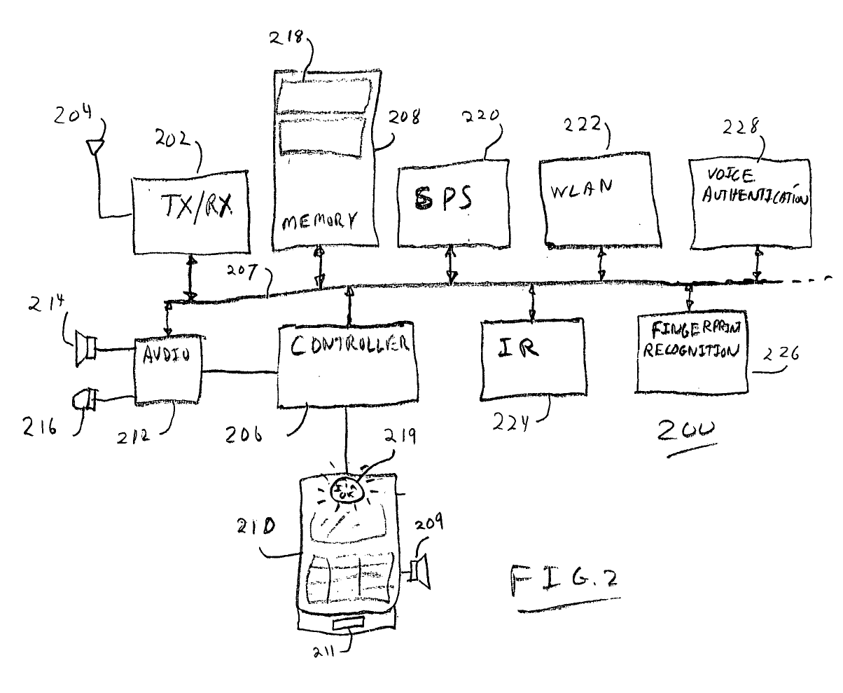

Referring now to FIG. 2, there is shown a block schematic diagram 200 of a mobile communication device having personal status reporting capability in accordance with the invention. The mobile communication device comprises a radio frequency transceiver 202 for modulating and transmitting radio signals, and receiving and demodulating radio signals via an antenna 204, as is known in the art. All components of the mobile communication device are operated under control of a controller 206. As shown here the mobile communication device component subsystems are operably coupled to the controller via a bus 207, but the controller may have direct connections to each subsystem, such as a serial interface, or there may be a combination of bus and direct connectivity. The controller executed machine readable code stored in a memory 208, and may have local memory as well. The memory shown here is an abstract representation of various kinds of memory the mobile communication device may have, such as RAM, ROM, reprogrammable and so on. The controller is linked to a user interface 210 including typically a display device for displaying information to the user and a keypad or button assembly for allowing the user to make selections, input information, and control operation of the mobile communication device. The user interface may also include other elements such as a mechanical vibrator 211, an audio transducer 209 for producing sounds, and light producing elements for other visual indications or backlighting the display or keypad and buttons. To facilitate voice and audio communication, the mobile communication device comprises an audio processor 212 which converts digital audio signals received from the transceiver into analog signals that are played over a speaker 214. The audio processor also receives analog signals from a microphone 216 and converts them to digital audio signals which are provided to the transceiver. It is also contemplated that the mobile communication device may include a video recording device for capturing images and video footage with the mobile communication device, and stored in the memory of the mobile communication device, or in an auxiliary memory contained in a peripheral device attached to the mobile communication device. It is further contemplated that a scent generating subsystem may be included in the mobile communication device to generate various scents, as determined by the user.

The mobile communication device operates in part according to machine readable code disposed in the memory. The instruction code is developed in code modules which each perform certain tasks, applications, and operations, and set up various modes of operation and processes. One such set of modules controls the operation of an event monitoring mode, which may be activated or deactivated by the user. When the event monitoring mode is activated, the mobile communication device compares input it receives with one or more event descriptor files 218, which are also stored in memory, and may be created, edited, and deleted by the user. When the event monitoring mode is invoked, the mobile communication device compares input received from various subsystem components with criteria in the event descriptor files. When the inputs are close enough to be considered a match, the event is generated, meaning the mobile communication device takes action to send a status response message. The mobile communication device may comprise, for example, a satellite positioning subsystem 220 for receiving satellite positioning signals from satellite positioning satellites and determining a precise present geographic location of the mobile communication device. Geographic location can be determined, with less precision, from other information, such as, for example, control information received at the transceiver from the communication system as many communication system base stations transmit information relating to their geographic location. The mobile communication device may also include wireless receivers for receiving information from local sources, such as an infrared subsystem 224 or a wireless local area network subsystem 222. These subsystems can receive information from local sources such as kiosks located in public places like airports and shopping centers, as mentioned hereinabove.

Alternatively, it is contemplated that the event may be a status inquiry message received at the mobile communication device via the communication system. Reception of the message is treated like any other event that may be described in an event descriptor file.

Once the mobile communication device has determined that an event has occurred, the mobile communication device can either automatically send a status message, or prompt the user and wait for an input before sending the status message. In prompting the user, the mobile communication device may use a variety of alert devices to get the user's attention, such as audio, visual and tactile alerts generated via the user interface, or even by means of a scent generated in response to the event. For example the mobile communication device may turn on a light element that backlights a status response button 219. The mobile communication device may also display a message on the display, turn on the mechanical vibrator 211, or play a sound on the speaker transducer 209, or any combination of these. Furthermore, the user may indicate how to alert the user in the event descriptor file. Once the user recognizes the prompt, the user may then respond by, for example, pressing a status response button. In some cases it may be desirable for the user to prove their identity, and thus the mobile communication device will authenticate the user. For example, if the event is the reception of a status query message, the person making the inquiry may want some assurance that the status message response was generated by the intended person.

There are a variety of means for authenticating the user of the mobile communication device, each with varying levels of complexity and corresponding assurance that the present operator of the mobile communication device is the correct person to respond to the event prompt. The simplest being a password challenge. The user provides a password to the mobile communication device before the event occurs. The password may be a general password for the mobile communication device, as is common, or the password may be provided in the event descriptor. More sophisticated means of authentication may be employed, such as a fingerprint recognition module 226 or a voice recognition authentication module 228. The fingerprint module works with special hardware disposed on the mobile communication device for receiving an optical scan of the user's fingerprint. The fingerprint is compared to the stored record of the user's fingerprint for authentication. Similarly, the voice recognition authentication module receives a speech segment of the user's voice, such as from the audio processor, and compares it to a stored version of the speech segment for authentication. The speech recognition module, although shown here as a module, may be entirely implemented by a digital signal processor of the mobile communication device executing voice recognition instruction code. Since digital signal processors ate commonly used in mobile communication devices, this form of authentication requires only the voice recognition instruction code, which is also fairly common in present-day mobile communication devices. It is also contemplated that the mobile communication device may comprise biometric sensors, or alternatively, the mobile communication device may use the WLAN subsystem to communicate with a biometric sensor worn by the user. The biometric sensors can read heart rate, skin temperature, and so on. These metrics may then be reported in the status message.

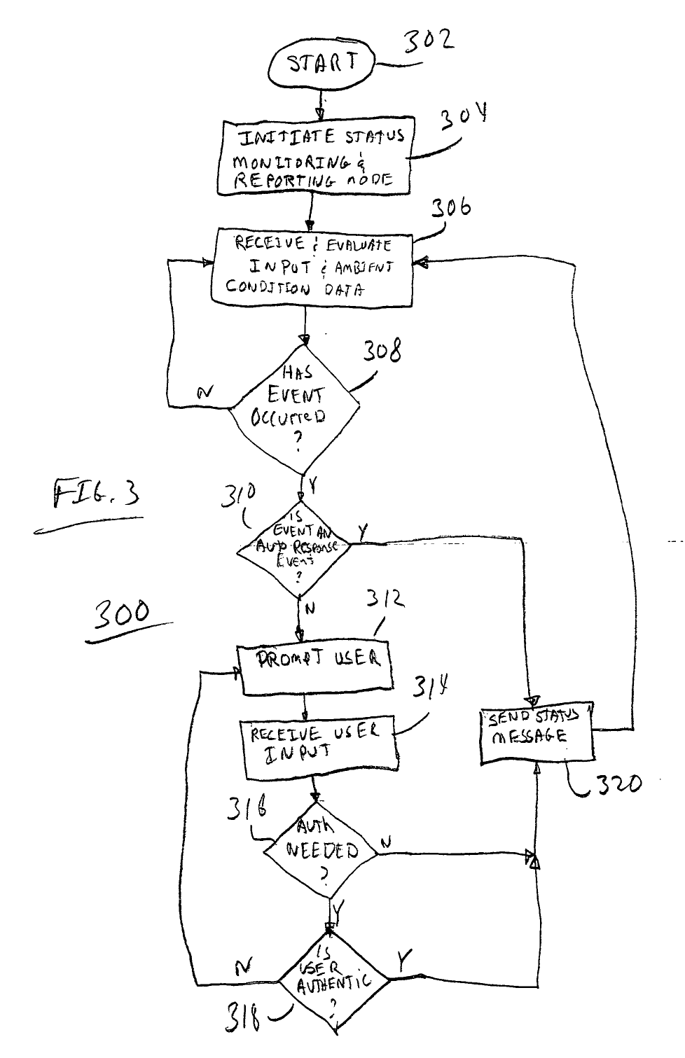

Referring now to FIG. 3, there is shown a flow chart diagram 300 of a method of reporting status of a user of a mobile communication device in accordance with the invention. At the start (302) of the method, the mobile communication device is powered up and at least one event descriptor has been provided to the mobile communication device. The event descriptor contains information and criteria to define an event and against which input and data collected by the mobile communication device is compared. The event descriptor may also contain information as to whether the event requires authentication, how to authenticate the user, where to send the status message, what mode of communication to use in sending the status message, and what information to send in the status message. The mobile communication device initiates status monitoring and reporting mode (304), which may occur upon an input from the user, or it may occur automatically upon powering up the mobile communication device. The initiating involves instantiating a software application that evaluates various parameters acquired by the mobile communication device that indicate the present ambient condition, which is compared to the event descriptor (306). The ambient condition of the mobile communication device may include the present geographic location of the mobile communication device, whether the mobile communication device has received a status query message, and any other condition that may give rise to an event that can be detected by the mobile communication device. The ambient condition parameters are compared to event descriptors to determine if an event has occurred (308). If the mobile communication device determines that no event has occurred, the mobile communication device continues monitoring the ambient condition and comparing it against the event descriptor. If an event has occurred, the mobile communication device determines whether the event is requires an automatic response (308). If an automatic response is required, meaning no action by the user is needed, the mobile communication device may send the status message immediately (320). If the event requires an input from the user, the mobile communication device commences prompting the user (312) to provide a response. The prompt may take any one of several forms, or a combination of several different alerts. For example, the mobile communication device may illuminate a status response button, display an image or icon on the display, play a sound, turn on a mechanical vibrator, and so on. After prompting the user, the mobile communication device waits for an input (314). If the event requires authentication of the user (316), the mobile communication device evaluates the input to see if it compares with stored information (318). If the user is authenticated, or if no authentication is required, the mobile communication device commences sending the status message. If authentication was required, and the input from the user did not verify the user as the intended user, the mobile communication device may again prompt the user. After the status message is sent the mobile communication device continues monitoring for additional events, if needed.

Thus the invention provides for a method of reporting the status of the user of a mobile communication device. The method includes the user providing at least one event descriptor to the mobile communication device. The event descriptor defines an event and may include criteria such as geographic location parameters, status inquiry parameters, time of day, and other conditions the mobile communication device may experience. The method commences by detecting the occurrence of the event as defined by the event descriptor. In one embodiment of the invention, once the event is detected, the mobile communication device commences transmitting a status message to a preselected party. 3. A method of monitoring status as defined in claim 1, wherein providing at least one criteria set comprises a time parameter. In one embodiment of the invention the method additionally comprises alerting the user of the mobile communication device of the occurrence of the event in response to detecting the occurrence of the event, after which or during which the mobile communication device commences prompting the user of the mobile communication device for an input from the user. The mobile communication device then monitors the user interface and commences receiving the input from the user before transmitting the status message. Prompting the user may be performed by the use of a visual indicator, such as illuminating a status response button on the mobile communication device. The prompting may include an auditory alert, or a tactile alert such as that created by operation of a mechanical vibrator. In one embodiment of the invention the method comprises authenticating the user, such as by identifying a fingerprint of the user, receiving a password entry from the user, or performing voice recognition on a speech segment spoken by the user in response to the prompting. Receiving the input from the user may comprise detecting an actuation of a status response button. In detecting the occurrence of the event, the mobile communication device, in one embodiment of the invention, commence detecting a present geographic location of the mobile communication device. The geographic location may be determined in several ways, including using a satellite positioning subsystem of the mobile communication device, or receiving location information from a base station providing communication service to the mobile communication device, for example. Another example of an event is receiving a message at the mobile communication device, such as a status inquiry message. In one embodiment of the invention the mobile communication device may also receive a local wireless message from a source other than a mobile communication system, such as by an infrared communication source or a wireless local area network source.

The invention also provides for a mobile communication device for use in a mobile communication system and for reporting a status of a user of the mobile communication device. The mobile communication device comprises a transceiver for communicating with the mobile communication system. The transceiver is capable of making voice and data and messaging calls. Disposed in the mobile communication device is a memory which, among other information, contains at least one event descriptor which defines an event. To operate the mobile communication device, the mobile communication device comprises a user interface for providing information to, and receiving input from the user. The mobile communication device also comprises a controller for evaluating the present status of the mobile communication device against an event descriptor in order to determine an occurrence of the event defined the event descriptor. The controller operates according to instruction code disposed in the memory, including status response instruction code which is executed upon the occurrence of the event, as determined by the controller. The status response code causes the mobile communication device to transmit a status response message to a preselected party.

In one embodiment of the invention, the event descriptor comprises a geographic location parameter corresponding to a geographic location. Therefore an event occurs when a present location of the mobile communication device is substantially equal to the geographic location defined in the event descriptor. While geographic location may be determined by several means, in one embodiment of the invention the mobile communication device comprises a satellite positioning subsystem for determining the present geographic location of the mobile communication device. Alternatively, the present geographic location of the mobile communication device may be determined by a control message received at the mobile communication device from a base station of the communication system that is presently providing communication service to the mobile communication device. Furthermore, it is contemplated that an event may be defined simply as the occurrence of a time of day. The time of day being determined by an internal clock of the mobile communication device or by a clock signal in a broadcast channel of the communication system. If a response is required by the event the mobile communication device comprises a means for alerting the user to the occurrence of the event, a means for prompting the user of the mobile communication device for an input from the user, and a means for receiving the input from the user before transmitting the status message. There are a variety of means for prompting the user that may be employed, such as a visual indicator. In the preferred embodiment the visual indicator comprises a selectably illuminable status response button, wherein the selectably illuminable response button is illuminated upon the occurrence of the event. That is, when the event occurs, the mobile communication device turns on a light element to illuminate the status response button. The light element, such as an light emitting diode, may be flashed to further attract attention. Another means for prompting the user comprises a speaker for producing an auditory alert, such as a beep. Alternatively, the means for prompting may include a mechanical vibrator. It is also contemplated that the means for prompting includes a display of the mobile communication device and at least one icon file describing an icon that is stored in the memory of the mobile communication device, where the mobile communication device commences displaying the icon on the display while prompting the user. The icon being a graphical image that is related to the event, such as an image or animated graphic file showing a landing airplane to be used in association with arriving at a destination airport.

If the event requires the user to be authenticated, the mobile communication device must include a means for authenticating the user, such as a fingerprint recognition subsystem, or a password challenge, or a voice recognition system. While the mobile communication device has a conventional user interface comprising a keypad and display, it is contemplated that the means for receiving the input comprises a status response button. The status response button is one that is larger than other buttons and placed on the mobile communication device in a location where it can be easily accessed and actuated upon an occurrence of an event.

The mobile communication device may further comprise additional subsystems for determining ambient parameters, such as the present location of the mobile communication device. Accordingly it is contemplated that the mobile communication device comprises a means for detecting a present geographic location, such as a satellite positioning subsystem, or a local wireless receiver subsystem for receiving local signals, where the local signals contain information relating to a present location of the mobile communication device.

In an alternative embodiment of the invention, the invention provides a method of reporting a status of a user of a mobile communication device by detecting the occurrence of a status event experienced by the mobile communication device, and then transmitting a status message from the mobile communication device to second party in response the status event. This embodiment of the invention permits a user to generate a status message at will, rather than having to preprogram an event descriptor file, and instead of engaging in a live call to a second party which the user wishes to inform of the user's present status. Although this alternative embodiment also allows for the user of event descriptors as described before, it also allows for detecting an input from the user of the mobile communication device indicating a desire to send a status message, such as by detecting actuation of a status response button of the mobile communication device, or equivalently a combination of button presses or the actuation of a so called soft key corresponding to a menu interface provided by the mobile communication device. It is further contemplated that the method of reporting status allows the user to send context information related to the event, or related to the reason for which the user desired to send the status message. For example, a context image may be used as the background of an image formed by a composite of the background image and text or other images or icons superimposed on the background image. The background image may be selected automatically, such as by including one in an event descriptor file, by providing a variety of background images that correspond to different events generally that the mobile communication device may select from. Alternatively the user may acquire an image, such as by a camera attached to, or integrated into the mobile communication device, and the captured image may be used as the background image.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method of reporting a status of a user of a mobile communication device, comprising:
providing at least one event descriptor defining an event in the mobile communication device;
detecting the occurrence of the event as defined by the event descriptor, performed by the mobile communication device;
transmitting a status message to a preselected party upon detecting the occurrence of the event.

2. A method of reporting status as defined in claim 1, wherein providing at least one event descriptor comprises providing geographic location parameter in the event descriptor.

3. A method of monitoring status as defined in claim 1, wherein providing at least one criteria set comprises a time parameter.

4. A method of reporting status as defined in claim 1, further comprising:
alerting a user of the mobile communication device of the occurrence of the event in response to detecting the occurrence of the event;
prompting the user of the mobile communication device for an input from the user; and
receiving the input from the user before transmitting the status message.

5. A method of reporting status as defined in claim 4, wherein prompting the user comprises a visual indicator.

6. A method of reporting status as defined in claim 5, wherein alerting the user with a visual indicator comprises illuminating a status response button on the mobile communication device.

7. A method of reporting status as defined in claim 4, wherein prompting the user for an input comprises prompting the user with an auditory alert.

8. A method of reporting status as defined in claim 4, wherein prompting the user for an input comprises prompting the user with a tactile alert.

9. A method of reporting status as defined in claim 8, wherein prompting the user with a tactile alert comprises prompting the user with a vibratory alert.

10. A method of reporting status as defined in claim 4, wherein receiving an input comprises authenticating the user.

11. A method of reporting status as defined in claim 10, wherein authenticating the user comprises identifying a fingerprint of the user.

12. A method of reporting status as defined in claim 10, wherein authenticating the user comprises receiving a password entry from the user.

13. A method of reporting status as defined in claim 10, wherein authenticating the user comprises performing voice recognition on a speech segment spoken by the user in response to the prompting.

14. A method of reporting status as defined in claim 4, wherein receiving the input comprises detecting an actuation of a status response button.

15. A method of reporting status as defined in claim 1, wherein detecting the occurrence of the event comprises detecting a present geographic location.

16. A method of reporting status as defined in claim 15, wherein detecting the present geographic location comprises using a satellite positioning subsystem of the mobile communication device to determine the present geographic location.

17. A method of reporting status as defined in claim 15, wherein detecting the present geographic location comprises receiving location information from a base station providing communication service to the mobile communication device.

18. A method of reporting status as defined in claim 1, wherein detecting the occurrence of the event comprises receiving a message at the mobile communication device.

19. A method of reporting status as defined in claim 18, wherein receiving the message at the mobile communication device comprises receiving a status inquiry message at the mobile communication device.

20. A method of reporting status as defined in claim 18, wherein receiving the message at the mobile communication device comprises receiving a local wireless message from a source other than a mobile communication system.

21. A method of reporting status as defined in claim 1, wherein transmitting the status message is performed automatically in response to detecting the occurrence of the event.

22. A mobile communication device for use in a mobile communication system and for providing a status of a user of the mobile communication device, comprising:
a transceiver for communicating with the mobile communication system;
memory containing at least one event descriptor, the event descriptor defining an event;
a user interface for providing information to, and receiving input from the user;
a controller for evaluating a present status of the mobile communication device against the at least one event descriptor for determining an occurrence of the event defined by the at least one event descriptor; and
status response instruction code disposed in the memory which is executed upon the occurrence of the event, as determined by the controller, the status response code causing the mobile communication device to transmit a status response message to a preselected party when executed by the mobile communication device.

23. A mobile communication device as defined in claim 22, wherein the at least one event descriptor comprises a geographic location parameter corresponding to a geographic location, the event occurring when a present location of the mobile communication device is substantially equal to the geographic location.

24. A mobile communication device as defined in claim 23 further comprising a satellite positioning subsystem for determining the present geographic location of the mobile communication device.

25. A mobile communication device as defined in claim 23 wherein the present geographic location of the mobile communication device is determined by a control message received at the mobile communication device transmitted by a base station of the communication system that is presently providing communication service to the mobile communication device.

26. A mobile communication device as defined in claim 22, wherein the at least one event descriptor comprises a time parameter corresponding to an event time, the event occurring when a present time is substantially equal to the event time.

27. A mobile communication device as defined in claim 22, further comprising:
means for alerting the user of the mobile communication device of the occurrence of the event in response to detecting the occurrence of the event;
means for prompting the user of the mobile communication device for an input from the user; and
means for receiving the input from the user before transmitting the status message.

28. A mobile communication device as defined in claim 27, wherein the means for prompting the user comprises a visual indicator.

29. A mobile communication device as defined in claim 28, wherein the visual indicator comprises a selectably illuminable status response button, wherein the selectably illuminable response button is illuminated upon the occurrence of the event.

30. A mobile communication device as defined in claim 27, wherein the means for prompting comprises a speaker for producing an auditory alert.

31. A mobile communication device as defined in claim 27, wherein the means for prompting comprises a mechanical vibrator.

32. A mobile communication device as defined in claim 27, further comprising a means for authenticating the user.

33. A mobile communication device as defined in claim 32, wherein the means for authenticating the user comprises a fingerprint recognition subsystem.

34. A mobile communication device as defined in claim 32, wherein the means for authenticating the user comprises a password stored in the memory of the mobile communication device which is compared against a password entered by the user in response to being prompted.

35. A mobile communication device as defined in claim 32, wherein the means for authenticating the user comprises a voice recognition subsystem and a stored speech segment stored in the memory of the mobile communication device.

37. A mobile communication device as defined in claim 27, wherein the means for receiving the input comprises a status response button.

38. A mobile communication device as defined in claim 22, further comprising a means for detecting a present geographic location.

39. A mobile communication device as defined in claim 38, wherein the means for detecting the present geographic location comprises a satellite positioning subsystem.

40. A mobile communication device as defined in claim 22, further comprising a local wireless receiver subsystem for receiving local signals, and wherein the local signals contain information relating to a present location of the mobile communication device.

41. A mobile communication device as defined in claim 27, wherein the means for prompting the user comprises a display of the mobile communication device and at least one icon file describing an icon and being stored in the memory of the mobile communication device, the mobile communication device displaying the icon on the display while prompting the user, and the icon being related to the event.

42. A method of reporting a status of a user of a mobile communication device, comprising:
detecting the occurrence of a status event experience by the mobile communication device; and
transmitting a status message from the mobile communication device to second party in response the status event.

43. A method of reporting status as defined in claim 42, wherein detecting the occurrence of the status event comprises detecting a status event defined by an event descriptor file in a memory of the mobile communication device.

44. A method of reporting status as defined in claim 42, wherein detecting the status event comprises detecting an input of a user of the mobile communication device indicating a desire to send a status message.

45. A method of reporting status as defined in claim 44, wherein detecting the input of the user comprises detecting actuation of a status response button of the mobile communication device.

46. A method of reporting status as defined in claim 43, wherein transmitting the status message includes transmitting context information.

47. A method of reporting status as defined in claim 44, wherein transmitting context information comprises selecting background information related to the status event and is performed automatically.

48. A method of reporting status as defined in claim 44, wherein transmitting context information comprises selecting background information selected by the user.

49. A method of reporting status as defined in claim 44, wherein transmitting context information comprises transmitting a background context image.

50. A method of reporting status as defined in claim 44, wherein transmitting context information comprises acquiring an image with the mobile communication device to be used as a background image.
